(19) United States
(12) Patent Application Publication
(10) Pub. No.: US 2007/0234605 A1
(43) Pub. Date: Oct. 11, 2007

(54) ROTATABLE LIP GLOSS DISPENSER NOVELTY

(76) Inventors: Thomas J. Coleman, Abingdon, VA (US); William K. Schlotter, Fredericksburg, VA (US); Princess Ann Coleman, Abingdon, VA (US); Ann M. Schlotter, Fredericksburg, VA (US)

Correspondence Address: CLYDE I. COUGHENOUR, 16607 SUTTON PLACE, WOODBRIDGE, VA, 22191, US

(21) Appl. No.: 11/278,791

(22) Filed: Apr. 5, 2006

(51) Int. Cl. G09F 19/08

(52) U.S. Cl. 40/419

(57) ABSTRACT

A lipstick or gloss applicator is provided with a container for lipstick or gloss that is attached to a brush handle. The container is closed with a conical slit wiper/scraper. The handle for the applicator has a cap for closing the container and houses a power source, motor and transmission for rotating an attached brush and parts of replicas of individuals, animals or objects and a light.

### BACKGROUND OF THE INVENTION

1. Field of the Invention

The invention is to a lip gloss balm or dispenser having a battery and motor that can rotate the brush and/or move portions of a novelty replica form used as a handle.

2. Description of Related Art

The provision of electric motors for brushes is old with R. Mosley, U.S. Pat. No. 4,845,796, issued Jul. 11, 1989; R. Athalye, U.S. Pat. No. 4,901,391, issued Feb. 20, 1990; and L. Diaz, U.S. Pat. No. 6,565,276, issued May 20, 2003, examples. Indicia novelty replicas used as container caps are old as exemplified by Yu Shih, U.S. Design Pat. No. 453,054, issued Jan. 22, 2002, and U.S. Des. Pat. No. 457,686, issued May 21, 2002, U.S. Design Pat. No. 460,217, issued Jul. 9, 2002. Brushes have been illuminated with V. Heinrich, U.S. Design Pat. No. 365,176, issued Dec. 12, 1995, and Emerick et al U.S. Design Pat. No. 464,489, issued Oct. 22, 2002, and Rudell et al, U.S. Pat. No. 6,062,936, issued May 16, 2000, examples. Providing a scraper or wiper for a cosmetic brush is old as shown by T. Kingsford, U.S. Pat. No. 4,194,848, issued Mar. 25, 1980.

### SUMMARY OF THE INVENTION

The invention is to a lipstick or lip gloss brush applicator modified for fun. The handle is provided with the standard cap having a brush and brush rod. The cap includes a handle with an outside in the form of a replica that can be a partial or whole representation of a real or imaginary animate, inanimate or plant object that is provided with one or more movable parts and an inside motion creating component containing a power source, motor and motion transmitting and converting devices. The movable parts and brush can be rotated or oscillated or reciprocated, and a wiper for the brush, and a light can be used to illuminate the area the brush is to be used on.

### BRIEF DESCRIPTION OF THE DRAWINGS

FIG. 1 is a front perspective view of an applicator of the invention with a section broken away showing the components used for producing motion.

FIG. 2 is a front perspective view of a second embodiment with a section broken out and the brush section separated from the reservoir section.

FIG. 3 is a front perspective view of a third embodiment with a section broken out and the brush section separated from the reservoir.

### DESCRIPTION OF THE PREFERRED EMBODIMENTS

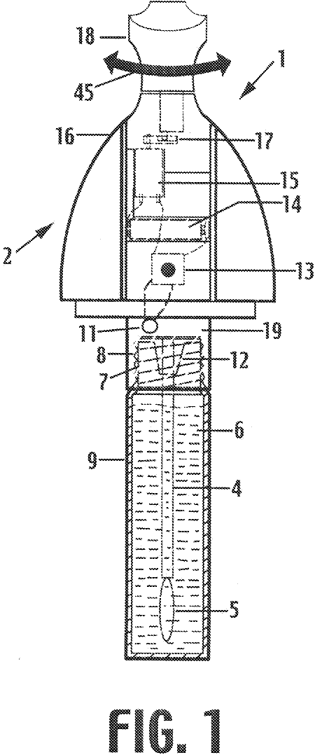

The applicator is shown in FIGS. 1-3. The reservoir or container 3 for holding the gloss or lipstick 6 is provided with a male threaded upper end 7 on receptacle 9. The upper end or extreme is covered with a wiper or scraper 12 that serves to both scrape excess gloss from the brush and to prevent spill from the receptacle. The scraper/wiper is preferably a plastic that extends over the upper end of the reservoir with a short portion and the slit wiper pressed into the upper end of the reservoir. The wiper has a central opening through blades formed by spaced slits in the cone shaped scraper to permit easy passage of the brush while removing excess gloss or lipstick from the brush as it passes the resilient blades of the scraper. The preferred lip gloss/lipstick used is transparent or translucent and can contain colored glitter.

In FIG. 1 the applicator 1 brush handle 2 is in the shape of a torso 18 with skirt 16 housing the components for creating movement and/or illumination. The lower extent of the handle 2 is provided with a cap 19, that can be transparent, having female connection threads 8 for engaging the male threads 7 of the reservoir 9 when the brush is placed within the reservoir for storage. The lower end of the skirt 16 can be provided with a light 11 used as an attraction or for illumination of lips or other surface the brush is to be used on.

The handle 2, skirt 16, houses a switching device 13, a power source 14, a direct drive motor 15, a cam 17, and wiring, for oscillating 45 the movable body part or torso 18, and illumination of the bulb 11.

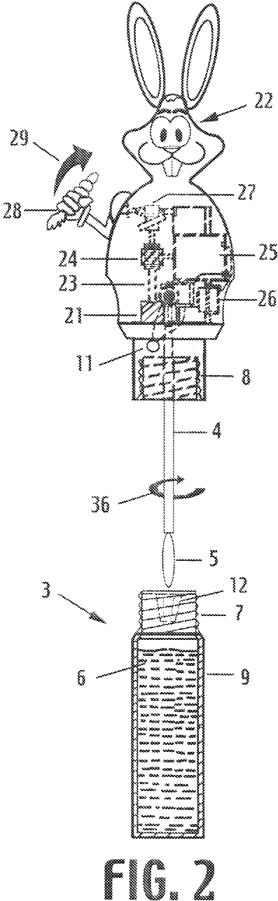

FIG. 2 shows a reservoir 3 the same as that of FIG. 1. The handle is in the shape of a rabbit and houses a power source 26, a motor 25, gears 24, a cam 27 with an appendage 28 in the shape of a hand holding a carrot that oscillates in a motion that resembles eating. The motor 25 drives gears 24 that connect with and rotate the shaft. The lower extent of the shaft drives bevel gears 21, one of which is on brush rod 4 that rotates the brush 5 to evenly distribute the lipstick or gloss from the brush to the lips. The upper shaft rotates a cam 27 that connects with and oscillates the movable appendage 28.

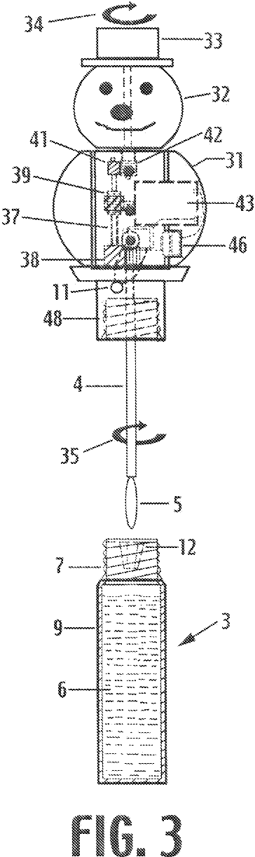

The embodiment shown in FIG. 3 incorporates the same reservoir 3 as in FIG. 1. The handle 31 is in the shape of a torso with a head appendage 32 on the torso. A hat appendage 33 is placed on the head and is rotated 34 by a shaft 42 extending from the gears 41 driven by the shaft 37 upper end. The shaft 37 lower end is provided with bevel gears 38 that connect to and drive and rotate 35 the brush 5. As with the other embodiments, a motor 43 drives the shaft 37 getting its power from a battery 46. The female connection 48 can be opaque with the light 11 on the upper inside of the female connection.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A cosmetic applicator comprising:
a container for a fluid cosmetic;
a handle for a brush;
a brush rod attached to said brush handle;
a brush attached to said brush rod;
said handle housing a motion creating means including a power source, motor, switching device, and transmission mechanism;
said handle being in the shape of a replica;
said replica having a movable appendage;
said replica movable appendage being movable by said motion creating means when activated by said switching device.

2. A cosmetic applicator as in claim 1 including:
a cap on said handle for attaching said handle to said container;
a light on said cap for illumination.

3. A cosmetic applicator as in claim 2 including:
a cosmetic in said container;
a glitter in said cosmetic.

4. A cosmetic applicator as in claim 1 wherein:
said brush rod is rotatable;
said motor is connect to said brush rod for rotating said brush.

5. A cosmetic applicator as in claim 1 including:
a cap on said handle for attaching said container to said handle;
said cap is transparent;
a light on said handle for illuminating through said transparent cap.

6. A cosmetic applicator as in claim 5 including:
a cosmetic in said container;
said cosmetic is a lip gloss;
sparkles in said lip gloss that can be illuminated by said light.

7. A cosmetic applicator as in claim 1 including:
a wiper attached to said container;
a cosmetic in said container;
said cosmetic is a lip gloss;
said brush and said brush rod extendable through said wiper into said container.

8. A cosmetic applicator as in claim 7 wherein:
said wiper is in the shape of a cone having slits that form resilient fingers for wiping excess lip gloss from said brush.

9. A cosmetic applicator as in claim 8 wherein:
said wiper has a flat top the diameter of the container top opening with a thickened inner area that is pressed into said container open end to secure the wiper to said container opening.

10. A cosmetic applicator as in claim 1 wherein:
said replica movable appendage is rotated in response to activation of said motor.

11. A cosmetic applicator as in claim 10 wherein:
said replica is in the general shape of a snowman with a torso and a head having a hat on said head;
said hat is said appendage that is rotated.

12. A cosmetic applicator as in claim 1 wherein:
said character movable appendage is oscillated in response to activation of said motor.

13. A cosmetic applicator as in claim 12 wherein:
said replica is in the general shape of a rabbit with a body, head and ears, having a hand holding a carrot that is oscillated toward and away from a mouth in a eating motion.

14. A cosmetic applicator as in claim 12 wherein:
said replica movable appendage is in the general shape of a torso and skirt with the torso oscillated in response to activation of said motor.

15. A cosmetic applicator as in claim 5 wherein:
said brush rod is rotatable;
said motor is connected to said brush rod for rotating said brush.

16. A cosmetic applicator as in claim 7 wherein:
said brush rod is rotatable;
said motor is connected to said brush rod for rotating said brush.

17. A cosmetic applicator as in claim 9 wherein:
said brush rod is rotatable;
said motor is connected to said brush rod for rotating said brush.

18. A cosmetic applicator as in claim 9 including:
a cap on said handle for attaching said container to said handle;
said cap is transparent;
a light on said handle for illuminating through said transparent cap.

19. A cosmetic applicator as in claim 18 wherein:
said brush rod is rotatable;
said motor is connected to said brush rod for rotating said brush.
